(19) United States
(12) Patent Application Publication
(10) Pub. No.: US 2019/0179540 A1
(43) Pub. Date: Jun. 13, 2019

(54) CONCURRENT ACCESS FOR MULTIPLE STORAGE DEVICES

(71) Applicant: QUALCOMM Incorporated, San Diego, CA (US)

(72) Inventors: Madhu Yashwanth BOENAPALLI, Hyderabad (IN); Surendra PARAVADA, Hyderabad (IN); Hyunsuk SHIN, San Diego, CA (US); Venu Madhav MOKKAPATI, Hyderabad (IN)

(21) Appl. No.: 15/838,348

(22) Filed: Dec. 11, 2017

(51) Int. Cl. G06F 3/06

(52) U.S. Cl. CPC G06F 3/0613; G06F 3/0635; G06F 3/065; G06F 3/0688

(57) ABSTRACT

In a conventional system with an embedded UFS and an external UFS card are connected to a UFS host, the UFS host is only able to transfer data to the embedded UFS or to the an external UFS card, but not to both at the same time. To address this issue, it is proposed to provide a host that is capable of concurrently transferring data to multiple storage devices.

### FIELD OF DISCLOSURE

One or more aspects of the present disclosure generally relate to memory systems, and in particular, to support concurrent accesses to multiple storage devices such as embedded UFS (Universal Flash Storage) devices and removable UFS cards.

### BACKGROUND

JEDEC (Joint Electron Device Engineering Council) promulgates several standards including the UFS standard for high performance mobile storage devices. The UFS has adopted MIPI (Mobile Industry Processor Interface) for data transfer in mobile systems. The UFS is a standard to provide high-performance serial interface for moving data between a host and a storage device.

UFS is well-suited for mobile applications (e.g., mobile phones, laptop computers, handheld devices, tablets, etc.) where high performance demands are seen in conjunction with low power consumption requirements. A UFS memory system may be an embedded device within a host such as a processor or an SoC (System-on-Chip), and/or may be integrated on a removable card, for flexible use with different hosts. Different standards and configurations may be applicable to the available UFS memory systems.

UFS memory systems and their interfaces to the hosts may include multiple layers to support the standards. The host may include an HCI (Host Controller Interface) and a UTP (UFS Transport Protocol) as defined in the JEDEC standard. The host may also include a Unipro (Unified Protocol) and a physical interface referred to as M-PHY (Mobile-PHYsical-Layer) as defined by MIPI. Within the host, the Unipro and the M-PHY are designed to communicate through an interface or bus referred to as an RMMI (Reference M-PHY Module Interface), which is also defined in MIPI.

A UFS memory system which communicates with the host may also include counterpart layers, UTP, Unipro, and M-PHY. Each M-PHY supports a specific number of bits or pins, referred to in units of lanes. Depending on the particular implementation, a UFS device may support one or more lanes. An embedded UFS is usually a single lane device, but there is an increasing demand for embedded UFS devices to support two lanes. A UFS card is typically a removable device, and supports a single lane of memory traffic.

In conventional implementations, a UFS host that is configured to support UFS devices of different lanes (e.g., a 2-lane embedded UFS and a 1-lane external UFS card) is integrated with dedicated hardware support for the different lanes of the UFS devices which are supported. This can lead to duplication of hardware and an accompanying increase in the chip-area resulting in inefficiencies and higher costs.

One way to minimize such hardware duplication is to incorporate to the UFS system an RMMI that routes traffic to the correct target device (to the embedded UFS or to the UFS card). With the RMMI, duplication of hardware to implement the HCI and the UTP can be avoided. Unfortunately, this can also lead to a reduced traffic rate since the embedded UFS and the external UFS card cannot be accessed concurrently.

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

An exemplary apparatus is disclosed. The apparatus may comprise a host configured to access first and second storage devices. The host may comprise a first PHY, a second PHY, a link controller, a command queue, and a transport controller. The first PHY may be configured to communicate with the first storage device over a first connection, and the second PHY may be configured to communicate with the second storage device over a second connection. The link controller may be configured to interface with the first PHY over a first link, and the command queue may be configured to interface with the second PHY over a second link. The transport controller may be configured to interface with the link controller and with the command queue. The transport controller may be configured to receive one or more request messages from an HCI. For each request message, the transport controller may be configured to generate a command packet corresponding to the request message, determine a target of the request message, send the command packet to the link controller if the target is the first storage device, and send the command packet to the command queue if the target is the second storage device. The link controller may be configured to provide each command packet received from the transport controller to the first link for transmission to the first storage device over the first connection by the first PHY. The command queue may be configured to queue the command packets received from the transport controller. The command queue may also be configured to provide each queued command packet to the second link one at a time for transmission to the second storage device over the second connection by the second PHY.

Another exemplary apparatus is disclosed. The apparatus may comprise first and second storage devices and a host configured access the first and second storage devices. The host may comprise a first PHY, a second PHY, a link controller, a command queue, and a transport controller. The first PHY may be configured to communicate with the first storage device over a first connection, and the second PHY may be configured to communicate with the second storage device over a second connection. The link controller may be configured to interface with the first PHY over a first link, and the command queue may be configured to interface with the second PHY over a second link. The transport controller may be configured to interface with the link controller and with the command queue. The transport controller may be configured to receive one or more request messages from an HCI. For each request message, the transport controller may be configured to generate a command packet corresponding to the request message, determine a target of the request message, send the command packet to the link controller if the target is the first storage device, and send the command packet to the command queue if the target is the second storage device. The link controller may be configured to provide each command packet received from the transport controller to the first link for transmission to the first storage device over the first connection by the first PHY. The command queue may be configured to queue the command packets received from the transport controller. The command queue may also be configured to provide each queued command packet to the second link one at a time for transmission to the second storage device over the second connection by the second PHY.

An exemplary method of an apparatus is disclosed. The apparatus may comprise a host configured access first and second storage devices. The method may comprise acts performed by a transport controller, a link controller, and a command queue. The acts performed by the transport controller may include receiving one or more request messages from an HCI, generating a command packet corresponding to each request message, determining a target of each request message, sending to the link controller each command packet whose corresponding request message targets the first storage device, and sending to the command queue each command packet whose corresponding request message targets the second storage device. The acts performed by the link controller may include sending each command packet received from the transport controller to a first PHY for transmission to the first storage device over a first connection. The acts performed by the command queue may include queueing the command packets received from the transport controller, and sending each queued command packet to a second PHY one at a time for transmission to the second storage device over a second connection.

Yet another exemplary apparatus is disclosed. The apparatus may comprise a host configured to access first and second storage devices. The host may comprise a first PHY, a second PHY, a link controller, a command queue, and a transport controller. The first PHY may be configured to communicate with the first storage device over a first connection, and the second PHY may be configured to communicate with the second storage device over a second connection. The link controller may be configured to interface with the first PHY over a first link, and the command queue may be configured to interface with the second PHY over a second link. The transport controller may be configured to interface with the link controller and with the command queue. The transport controller may comprise means for receiving one or more request messages from an HCI, means for generating command packet corresponding to each request message, means for determining a target of each request message, means for sending each command packet whose corresponding request message targets the first storage device to the link controller, and means for sending each command packet whose corresponding request message targets the second storage device to the command queue. The link controller may be configured to provide each command packet received from the transport controller to the first link for transmission to the first storage device over the first connection by the first PHY. The command queue may comprise means for queuing command packets received from the transport controller. The command queue may also comprise means for providing each queued command packet to the second link one at a time for transmission to the second storage device over the second connection by the second PHY.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates an existing UFS system with a UFS host connected to an embedded UFS device and to an external UFS card;

FIG. 2 illustrates an apparatus with a host configured to communicate with an internal storage device and an external storage device;

FIG. 3 illustrates an example logic flow in the apparatus of FIG. 2 to minimize power consumption;

FIG. 4 illustrates another example logic flow in the apparatus of FIG. 2 to minimize power consumption;

FIG. 5 illustrates a flow chart of an example method performed by the host of the apparatus of FIGS. 2, 3, and 4;

FIGS. 6, 7, and 8 illustrate flow charts of example processes performed by a transport controller, a link controller, and a command queue of the host of the apparatus of FIGS. 2, 3, and 4; and

FIG. 9 illustrates examples of devices with a host and a plurality of devices daisy-chained to the host integrated therein.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments of the disclosed subject matter include the discussed feature, advantage or mode of operation.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, processes, operations, elements, and/or components, but do not preclude the presence or addition of one or more other features, integers, processes, operations, elements, components, and/or groups thereof.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the examples described herein, the corresponding form of any such examples may be described herein as, for example, “logic configured to” perform the described action.

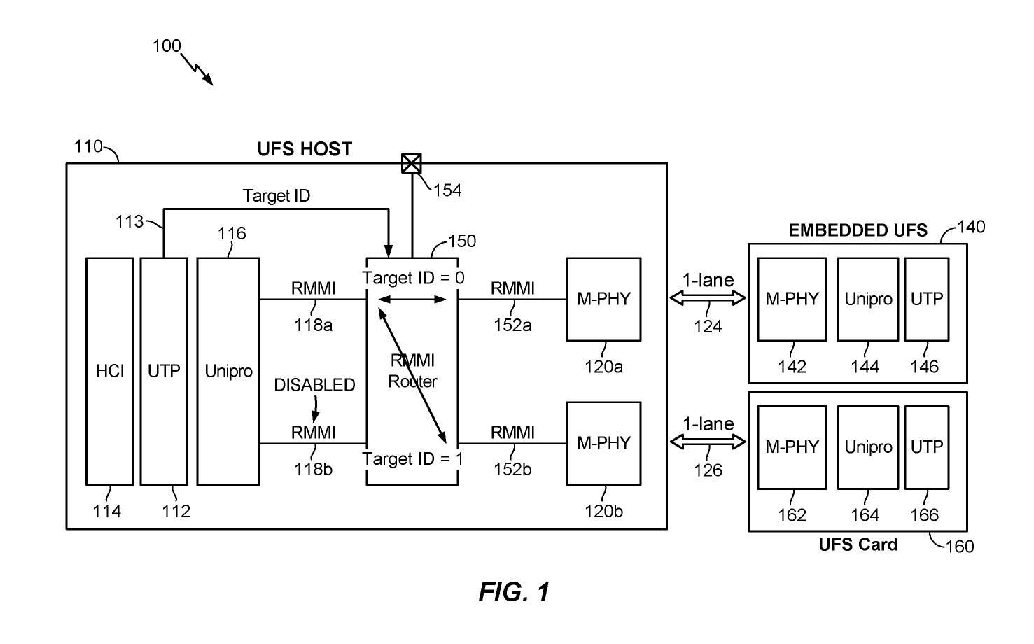

Recall from above that one disadvantage (of which there can be several) of an existing UFS system is a lack of concurrent access to the embedded UFS device and to the external UFS card. FIG. 1 illustrates an existing UFS system 100 that includes a UFS host 110 connected to a 1-lane embedded UFS device 140 via a first connection 124. The UFS host 110 is also connected to an external UFS card 160 via a second connection 126. In this instance, both the first and second connections 124, 126 are single lane connections.

The embedded UFS device 140 includes an M-PHY 142, a Unipro 144 and a UTP 146 to support the first connection 124 to UFS host 110. Similarly, the external UFS card 160 includes an M-PHY 162, a Unipro 164 and a UTP 166 to support the second connection 126 to UFS host 110.

The UFS host 110 includes an HCI 114, a UTP 112, a Unipro 116, and first and second M-PHYs 120a, 120b. The UFS host 110 also includes an RMMI router 150. RMMIs 118a and 118b are coupled between the Unipro 116 and the RMMI router 150. An RMMI 152a is coupled between the RMMI router 150 and the first M-PHY 120a, and an RMMI 152b is coupled between the RMMI router 150 and the first M-PHY 120a. The first M-PHY 120a interfaces with the embedded UFS device 140 via the first connection 124, and the second M-PHY 120b interfaces with the external UFS card 160 via the second connection 126.

When the HCI 114 issues a command (e.g., read/write) that generates traffic, the UTP 112 keeps track of the target ID which indicates whether the traffic is directed to the embedded UFS device 140 or to the external UFS card 160. The UTP 112 delivers the target ID to the RMMI router 150 via a line 113. The Unipro 116 is set to be in a 1-lane mode and one of the RMMIs, in this case, the RMMI 118b, is disabled.

The RMMI router 150 can be programmed via a metal strap 154 (or a ROM setting) to be in a routing mode. Based on the target ID, the RMMI router 150 routes the traffic to either the first M-PHY 120a through the RMMI 152a (e.g., if the target ID=0 to indicate the embedded UFS device 140 as the target) or to the second M-PHY 120b through the RMMI 152b (e.g., if the target ID=1 to indicate the external UFS card 160 as the target).

With the UFS system 100, the UFS host 110 can transfer data to the embedded UFS device 140 or to the external UFS card 160, but cannot transfer concurrently to both. For example, if the target for a current access command is the embedded UFS device 140 (or the external UFS card 160), and for the next access command, the target switches to the external UFS card 160 (or the embedded UFS device 140), an indication is sent via the line 113 to the RMMI router 150 that there has been a change in the target. Correspondingly, execution of commands and flow of traffic to the new target indicated by the changed target ID is stalled until all existing/current transactions to the current target ID have been completed. In other words, requests to the embedded UFS device 140 (or the external UFS card 160) are halted while the external UFS card 160 (or the embedded UFS device 140) is accessed.

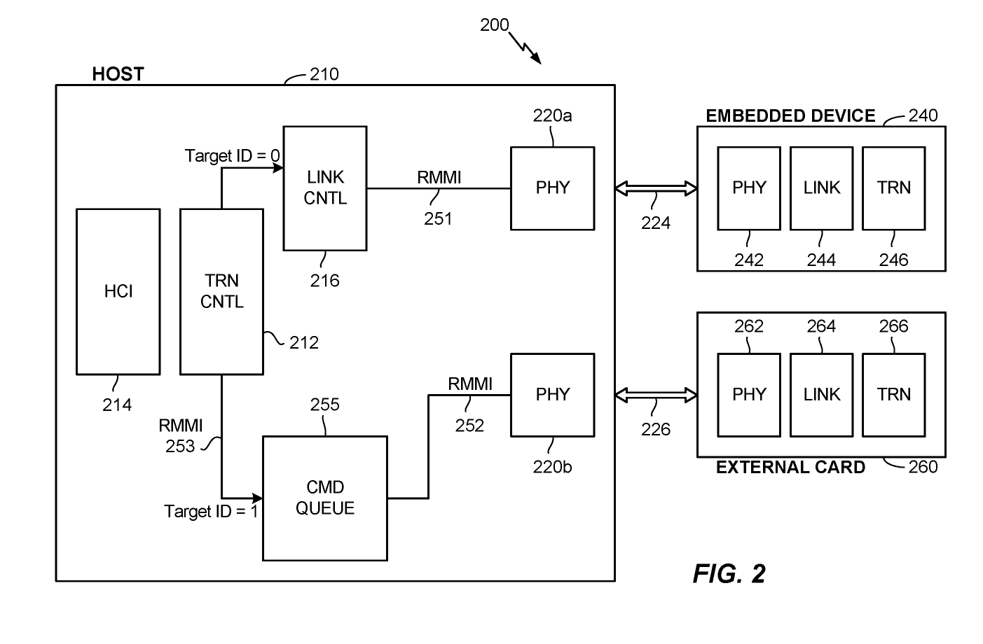

FIG. 2 illustrates an example of an apparatus 200 that addresses some or all issues related to conventional data storage systems such as the UFS system 100. In particular, the apparatus 200 enables concurrent transfers to occur. The apparatus 200 may include a host 210 configured to communicate with a first storage device 240 over a first connection 224. The host 210 may also be configured to communicate with a second storage device 260 over a second connection 226. While two devices are illustrated, it should be noted that the host 210 may communicate with any number of devices.

The first storage device 240 may be a UFS (Universal Flash Storage) device. In an aspect, the first storage device 240 may be an embedded storage device. In other words, the first storage device 240 may be integrated with the host 210 such that the two are not separable from each other. The first storage device 240 may comprise a first device PHY interface 242 configured to communicate with the host 210 over the first connection 224. The first connection 224 may comprise one or more lanes, referred to as “first lanes” for ease of reference. The first device PHY interface 242 may operate in compliance with M-PHY (Mobile-PHYsical-Layer). While not specifically illustrated, it should be noted that physically, the number of M-PHYs that make up the first device PHY interface 242 may equal the number of first lanes of the first connection 224. The first storage device 240 may also comprise a first device link interface 244 and a first device transport interface 246. The first device link interface 244 may operate in compliance with Unipro (Unified Protocol), and the first device transport interface 246 may operate in compliance with UTP (UFS Transport Protocol).

The second storage device 260 may also be a UFS device. In an aspect, the second storage device 260 may be an external storage card removable from the host 210. The second storage device 260 may comprise a second device PHY interface 262 configured to communicate with the host 210 over the second connection 226, which may comprise one or more second lanes, referred to as “second lanes” for ease of reference. The second device PHY interface 262 may operate in compliance with M-PHY. While not specifically illustrated, the number of M-PHYs that make up the second device PHY interface 262 may equal the number of second lanes of the second connection 226. The second storage device 260 may also comprise a second device link interface 264 and a second device transport interface 266. The second device link interface 264 may operate in compliance with Unipro, and the second device transport interface 266 may operate in compliance with UTP.

The host 210 may access the first and second storage devices 240, 260 respectively through the first and second connections 224, 226. The host 210 may be a processor or an SoC (System-on-Chip), and may comprise first and second PHYs 220a, 220b. The first PHY 220a may be configured to communicate with the first storage device 240 over the first connection 224, and the second PHY 220b may be configured to communicate with the second storage device 260 over the second connection. In an aspect, one or both of the first and second PHYs 220a, 220b may be configured to operate in compliance with M-PHY. While not specifically illustrated, the number of M-PHYs that make up the first PHY 220a may equal the number of first lanes of the first connection 224, and the number of M-PHYs that make up the second PHY 220b may equal the number of second lanes of the second connection 226.

The host 210 may also comprise a link controller 216 and a command queue 255. The link controller 216 may be configured to interface with the first PHY 220a over a first link 251, and the command queue 255 may be configured to interface with the second PHY 220b over a second link 252. One or both of the first and second links 251, 252 may be configured to operate in compliance with RMMI (Reference M-PHY Module Interface). Also, one or both of the link controller 216 and the command queue 255 may operate in compliance with Unipro.

The host 210 may further comprise a transport controller 212 configured to interface with the link controller 216 and with the command queue 255. The transport controller 212 may be configured to operate in compliance with UTP. In an aspect, the transport controller 212 may be configured to receive one or more request messages from an HCI (Host Controller Interface) 214. For example, the transport controller 212 may receive UCS (UFS Command Set Layer) commands from the HCI 214.

The transport controller 212 may be configured to generate a command packet corresponding to each request message received from the HCI 214. For example, the transport controller 212 may generate a UPIU (UFS Protocol Information Unit) for each request message. Also for each request message from the HCI 214, the transport controller 212 may be configured to determine the target of the request message.

If the target is the first storage device 240 (e.g., the Target ID=0), the transport controller 212 may send the corresponding command packet to the link controller 216. If the target is the second storage device 260 (e.g., the Target ID=1), the transport controller 212 may send the corresponding command packet to the command queue 255.

Thus, the link controller 216 may receive one or more command packets from the transport controller 212. The link controller 216 may be configured to provide each received command packet to the first link 251. The first PHY 220a in turn may transmit each command packet provided on the first link 251 to the first storage device 240 over the first connection 224. In an aspect, the link controller 216 may provide each received command to the first link 251 as soon as it the command packet is received. In other words, the link controller 216 may provide no queuing of the received command packet.

The command queue 255 may also receive one or more command packets from the transport controller 212. Unlike the link controller 216, the command queue 255 may be configured to queue the received command packets in a queue storage accessible to the command queue 255. For example, the queue storage may be within the command queue 255. The command queue 255 may also be configured provide each queued command packet one at a time to the second link 252. The queued command packets may be provided in a FIFO (first-in-first-out) manner. The second PHY 220b in turn may transmit each command packet provided on the second link 252 to the second storage device 260 over the second connection 226.

During operation, when requests (e.g., read/write requests) targeting the second storage device 260 (e.g., an external UFS card) arrive to the host 210 while the host 210 is communicating with the first storage device 240 (e.g., an embedded UFS), then the corresponding command packets can be queued (e.g., by the command queue 255). Once the corresponding command packets enter the queue, host 210 can send the command packets to both the first and second storage devices 240, 260 together one after the other in a pipeline (e.g., by the first and second PHYs 220a, 220b). In other words, the link controller 216 providing the received command packets on the first link 251 can occur concurrently with the command queue 255 providing the queued command packets on the second link 252.

If there are no requests for the first storage device 240, then the command queue 255 may simply behave like a buffer following the FIFO principle for accessing the second storage device 260.

On the other hand, when requests targeting the first storage device 240 arrive while the host 210 is communicating with the second storage device 260, then the host 210 may simply send the command packets of both the first and second storage devices 240, 260 together one after the other in the pipeline (e.g., by the first and second PHYs 220a, 220b). This again demonstrates that the link controller 216 providing the received command packets on the first link 251 can occur concurrently with the command queue 255 providing the queued command packets on the second link 252.

FIG. 2 may be viewed as representing an example logic flow in a scenario when both paths—a first path to access the first storage device 240 and a second path to access the second storage device 260—are busy. In this scenario, there are requests targeting both the first and second storage devices 240, 260.

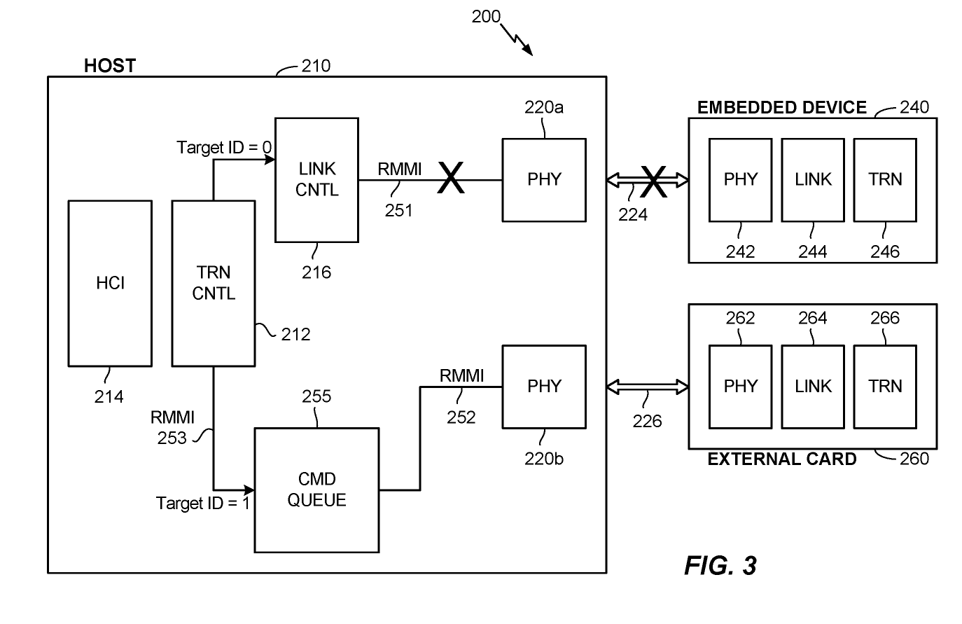

However, that can be instances when one or both of the first and second paths are not busy. These represent opportunities to save on power consumption. FIG. 3 illustrates an example logic flow in the apparatus 200 to minimize power consumption when the first path is idle (not busy). As an example, the first path may be determined to be idle when the transport controller 212 does not receive any request messages targeting the first storage device 240 for a first threshold duration of time.

When the first path is idle (as indicated by “X” on the first link 251 and the first connection 224), then power consumption can be reduced by putting the first path into a deep-sleep mode. Within the host 210, one or both of the link controller 216 and the first PHY 220a may be put into the deep-sleep mode. The first storage device 240 may also be put into the deep-sleep mode. For example, if the first storage device 240 is a UFS device, then the first storage device 240 may be put into a “Hibern8” mode. In an aspect, clock-gating may be used to put any one or more of the link controller 216, the first PHY 220a, and the first storage device 240 into the deep-sleep mode.

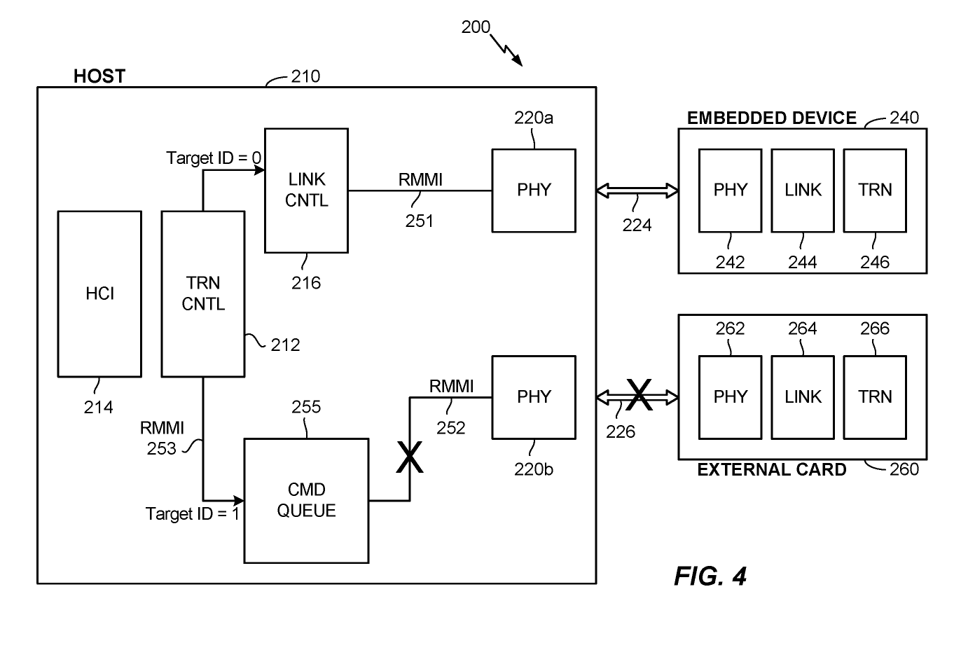

FIG. 4 illustrates an example logic flow in the apparatus 200 to minimize power consumption when the second path is idle (not busy). As an example, the second path may be determined to be idle when the command queue 255 is empty for a second threshold duration of time.

When the second path is idle (as indicated by “X” on the second link 252 and the second connection 226), then power consumption can be reduced by putting the second path into the deep-sleep mode. Within the host 210, one or both of the command queue 255 and the second PHY 220b may be put into the deep-sleep mode. The second storage device 260 may also be put into the deep-sleep mode. For example, if the second storage device 240 is a UFS device, then the second storage device 260 may be put into the “Hibern8” mode. In an aspect, clock-gating may be used to put any one or more of the command queue 255, the second PHY 220b, and the second storage device 260 into the deep-sleep mode.

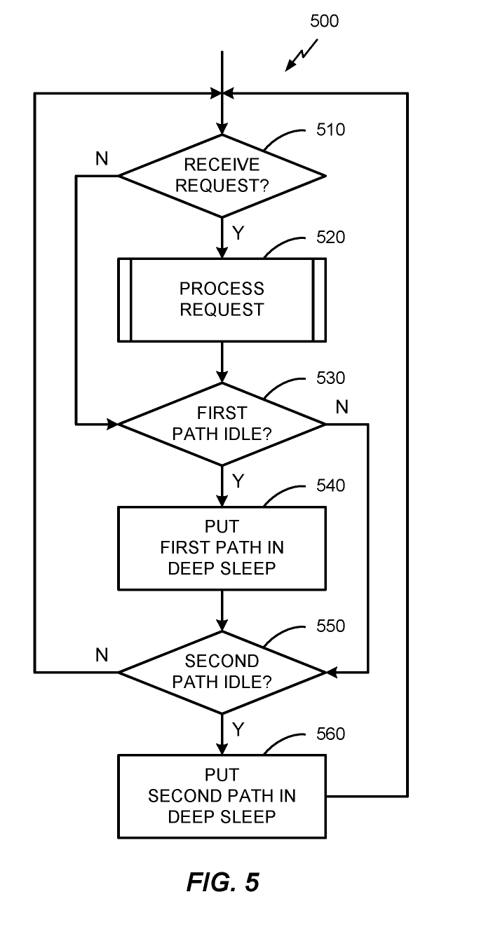

FIG. 5 illustrates a flow chart of an example method 500 performed by the host 210. It should be noted that not all illustrated blocks of FIG. 5 need to be performed, i.e., some blocks may be optional. Also, the numerical references to the blocks in FIG. 5 should not be taken as requiring that the blocks should be performed in a certain order. Indeed, some blocks may be performed concurrently.

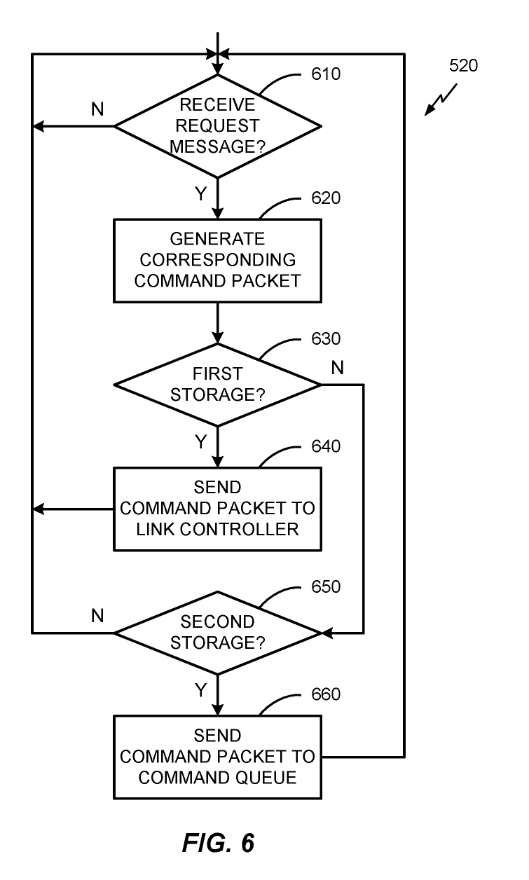

In block 510, the host 210 may determine whether a request has been received. If there is a request (“Y” branch from block 510), then in block 520, host 210 may process the request in block 520. Details for processing the request will be discussed in further detail below with reference to FIGS. 6, 7, and 8. If no request is received (“N” branch from block 510) or the received request has been processed (in block 520), then the method may proceed to block 530.

In block 530, the host 210 may determine whether the first path is idle. For example, the first path may be determined to be idle when the transport controller 212 does not receive any request messages targeting the first storage device 240 for the first threshold duration of time. More generally, the first path may be considered to be idle if the host 210 does not receive any requests to access the first storage device 240 for the first threshold duration.

If the first path is determined to be idle (“Y” branch from block 530), then in block 540, the host 210 may put the first path into the deep-sleep mode. For example, any one or more of the link controller 216, the first PHY 220a, and the first storage device 240 may be put into the deep-sleep mode (e.g., in Hibern8 mode). In an aspect, clock-gating may be used to effectuate the deep-sleep mode. If the first path is not idle (“N” branch from block 530) or the first path has been put into the deep-sleep mode (in block 540), then the method 500 may proceed to block 550.

In block 550, the host 210 may determine whether the second path is idle. For example, the second path may be determined to be idle when the command queue 255 is empty for the second threshold duration of time. More generally, the second path may be considered to be idle if the host 210 has not sent any command packets to the second storage device 260 for the second threshold duration.

If the second path is determined to be idle (“Y” branch from block 550), then in block 560, the host 210 may put the second path into the deep-sleep mode. For example, any one or more of the command queue 255, the second PHY 220b, and the second storage device 260 may be put into the deep-sleep mode (e.g., in Hibern8 mode). In an aspect, clock-gating may be used to effectuate the deep-sleep mode. If the second path is not idle (“N” branch from block 550) or the second path has been put into the deep-sleep mode (in block 560), then the method 500 may proceed back to block 510.

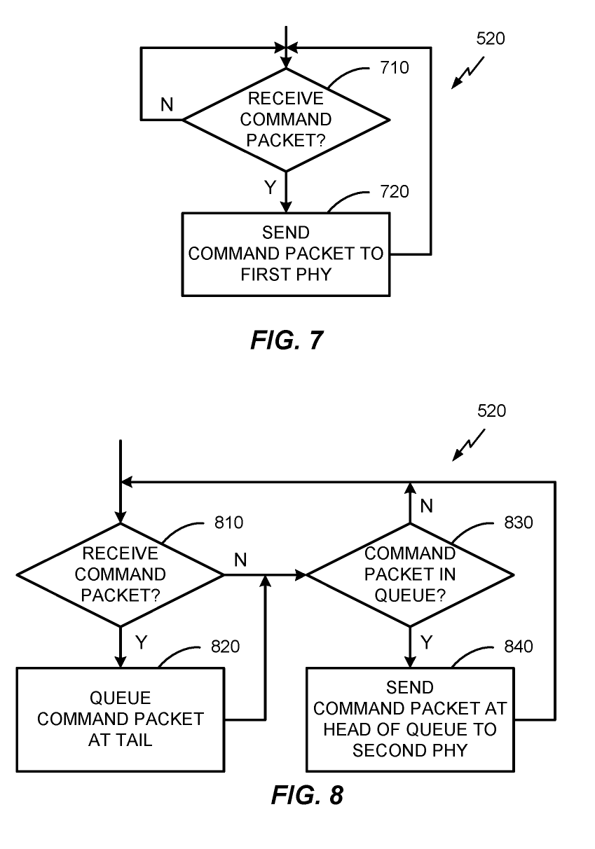

FIGS. 6, 7, and 8 illustrates flow charts of example operations performed by the host 210 to effectuate block 520 to process the received requests. In particular, FIG. 6 illustrates a flow chart of example operations performed by the transport controller 212, FIG. 7 illustrates a flow chart of example operations performed by the link controller 216, and FIG. 8 illustrates a flow chart of example operations performed by the command queue 255. Again, it is to be noted that not all illustrated blocks of FIGS. 6, 7, and 8 are necessarily required to be performed, i.e., some blocks may be optional. Also, the numerical references to the blocks in FIGS. 6, 7, and 8 should not be taken as requiring that the blocks should be performed in a certain order. Also, one or more of the illustrated blocks may be performed concurrently.

With reference to FIG. 6, in block 610, the transport controller 212 may determine whether a request message from the HCI 214 has been received. If it is determined that the request message has not been received (“N” branch from block 610), the transport controller 212 may repeat block 610. If the request message has been received (“Y” branch from block 610), then the operation may proceed to block 620.

In block 620, the transport controller 212 may generate a command packet corresponding to the request message. In block 630, the transport controller 212 may determine whether the target of the request message is the first storage device 240 (e.g., Target ID=0). If so (“Y” branch from block 630), then in block 640, the transport controller 212 may send the corresponding command packet to the link controller 216. Thereafter, the operation of the transport controller 212 may proceed back to block 610. On the other hand, if it is determined that the first storage device 240 is not the target (“N” branch from block 630), then the operation may proceed to block 650.

In block 650, the transport controller 212 may determine whether the target of the request message is the second storage device 260 (e.g., Target ID=1). If so (“Y” branch from block 650), then in block 660, the transport controller 212 may send the corresponding command packet to the command queue 255. Thereafter, the operation of the transport controller 212 may proceed back to block 610. The operation may also proceed back to block 610 if it is determined that the second storage device 260 is not the target (“N” branch from block 650).

With reference to FIG. 7, in block 710, the link controller 216 may determine whether a command packet from transport controller 212 has been received. Note that in an aspect, the link controller 216 will receive the command packet whenever the transport controller 212 performs block 640. If it is determined that the command packet has not been received (“N” branch from block 710), the link controller 216 may repeat block 710. If the command packet has been received (“Y” branch from block 710), then the operation of the link controller 216 may proceed to block 720.

In block 720, the link controller 216 may send the received command packet to the first PHY 220a. For example, the received command packet may be provided on the first link 251. The first PHY 220a in turn may transmit the command packet to the first storage device 240 over the first connection 224.

With reference to FIG. 8, in block 810, the command queue 255 may determine whether a command packet from transport controller 212 has been received. Note that in an aspect, the command queue 255 will receive the command packet whenever the transport controller 212 performs block 660. If it is determined that the command packet has been received (“Y” branch from block 810), the command queue 255 may proceed to block 820.

In block 820, the command queue 255 may queue the received command packet. For example, to implement the FIFO queue, the command queue 255 may store the received command packet at the tail of the queue. The operation of the command queue 255 may then proceed to block 830. The operation of the command queue 255 may also proceed to block 830 if it is determined that the command packet has not been received (“N” branch from block 810).

In block 830, the command queue 255 may determine whether there are any queued command packets, i.e., determine whether there are command packets in the queue that have not yet been sent. If so (“Y” branch from block 830), then the command queue 255 may send one of the queued command packets to the second PHY 220b. For example, the command packet at the head of the queue may be provided on the second link 252. The second PHY 220b in turn may transmit the command packet to the second storage device 260 over the second connection 226. The operation may then proceed back to block 810. The operation of the command queue 255 may also proceed back to block 810 if it is determined that the queue is empty (“N” branch from block 830).

Note that as long as there are queued command packets (i.e., the queue is not empty), the command queue 255 will send the queued command packets, one at time, on the second link 252. In this way, the second PHY 220b to transmit the sent command packets to the second storage device 260. Also note that the link controller 216 sending the received command packets to the first PHY 220a (block 720) can occur concurrently with the command queue 255 sending the queued command packets to the second PHY 220b (block 820).

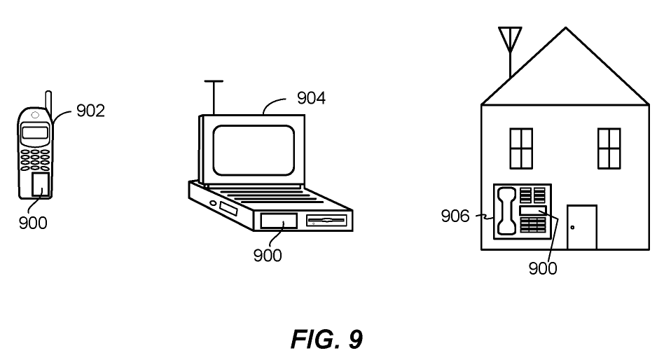

FIG. 9 illustrates various electronic devices that may be integrated with the aforementioned apparatuses illustrated in FIGS. 2, 3, and 4. For example, a mobile phone device 902, a laptop computer device 904, a terminal device 906 as well as wearable devices, portable systems, that require small form factor, extreme low profile, may include an apparatus 900 that incorporates the devices/systems as described herein. The apparatus 900 may be, for example, any of the integrated circuits, dies, integrated devices, integrated device packages, integrated circuit devices, device packages, integrated circuit (IC) packages, package-on-package devices, system-in-package devices described herein. The devices 902, 904, 906 illustrated in FIG. 9 are merely exemplary. Other electronic devices may also feature the device/package 900 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithms described in connection with the examples disclosed herein may be implemented as electronic hardware, computer software, or combinations of both. To clearly illustrate this interchangeability of hardware and software, various illustrative components, blocks, modules, circuits, and methods have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled with the processor such that the processor can read information from, and write information to, the storage medium. In the alternative, the storage medium may be integral to the processor.

Accordingly, an aspect can include a computer-readable media embodying any of the devices described above. Accordingly, the scope of the disclosed subject matter is not limited to illustrated examples and any means for performing the functionality described herein are included.

While the foregoing disclosure shows illustrative examples, it should be noted that various changes and modifications could be made herein without departing from the scope of the disclosed subject matter as defined by the appended claims. The functions, processes and/or actions of the method claims in accordance with the examples described herein need not be performed in any particular order. Furthermore, although elements of the disclosed subject matter may be described or claimed in the singular, the plural is contemplated unless limitation to the singular is explicitly stated.

What is claimed is:

1. An apparatus, comprising:
a host configured to access first and second storage devices, the host comprising:
a first PHY configured to communicate with the first storage device over a first connection, and a second PHY configured to communicate with the second storage device over a second connection;
a link controller configured to interface with the first PHY over a first link;
a command queue configured to interface with the second PHY over a second link; and
a transport controller configured to interface with the link controller and with the command queue,
wherein the transport controller is configured to
receive one or more request messages from an HCI (host controller interface), and
for each request message, generate a command packet corresponding to the request message, determine a target of the request message, send the command packet to the link controller if the target is the first storage device, and send the command packet to the command queue if the target is the second storage device,
wherein the link controller is configured to provide each command packet received from the transport controller to the first link for transmission to the first storage device over the first connection by the first PHY, and
wherein the command queue is configured to
queue the command packets received from the transport controller, and
provide each queued command packet to the second link one at a time for transmission to the second storage device over the second connection by the second PHY.

2. The apparatus of claim 1, wherein the host is configured such that the link controller providing the received command packets to the first link concurrently occurs with the command queue providing the queued command packets to the second link.

3. The apparatus of claim 1,
wherein the first storage device is an embedded storage device integrated with the host, and
wherein the second storage device is an external storage card removable from the host.

4. The apparatus of claim 1, wherein the first storage device and the second storage device are both UFS (Universal Flash Storage) devices.

5. The apparatus of claim 1,
wherein the first and second PHYs are configured to operate in compliance with M-PHY (Mobile-PHYsical-Layer),
wherein the link controller and the command queue are configured to operate in compliance with Unipro (Unified Protocol), and
wherein the transport controller is configured to operate in compliance with UTP (UFS Transport Protocol).

6. The apparatus of claim 5, wherein the transport controller is configured to generate UPIUs (UFS Protocol Information Units) as the command packets.

7. The apparatus of claim 1, wherein the command queue is configured to provide each queued command packet to the second link one at a time in a FIFO (first-in-first-out) manner.

8. The apparatus of claim 1, wherein the link controller does not queue the command packets received from the transport controller.

9. The apparatus of claim 1, wherein the host is configured to put one or both of the link controller and the first PHY in a deep-sleep mode if the transport controller does not receive any request message targeting the first storage device for a first threshold duration.

10. The apparatus of claim 1, wherein the host is configured to put one or both of the command queue and the second PHY in a deep-sleep mode if the command queue is empty for a second threshold duration.

11. The apparatus of claim 1,
wherein the first connection comprises one or more first lanes, or
wherein the second connection comprises one or more second lanes, or
both.

12. The apparatus of claim 1, wherein the apparatus is incorporated into a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

13. An apparatus, comprising:
first and second storage devices; and
a host configured to access the first and second storage devices, the host comprising:
a first PHY configured to communicate with the first storage device over a first connection, and a second PHY configured to communicate with the second storage device over a second connection;
a link controller configured to interface with the first PHY over a first link;
a command queue configured to interface with the second PHY over a second link; and
a transport controller configured to interface with the link controller and with the command queue,
wherein the transport controller is configured to
receive one or more request messages from an HCI (host controller interface), and
for each request message, generate a command packet corresponding to the request message, determine a target of the request message, send the command packet to the link controller if the target is the first storage device, and send the command packet to the command queue if the target is the second storage device,
wherein the link controller is configured to provide each command packet received from the transport controller to the first link for transmission to the first storage device over the first connection by the first PHY, and
wherein the command queue is configured to
queue the command packets received from the transport controller, and
provide each queued command packet to the second link one at a time for transmission to the second storage device over the second connection by the second PHY.

14. The apparatus of claim 13, wherein the host is configured such that the link controller providing the received command packets to the first link concurrently occurs with the command queue providing the queued command packets to the second link.

15. The apparatus of claim 13,
wherein the first storage device is an embedded storage device integrated with the host, and
wherein the second storage device is an external storage card removable from the host.

16. The apparatus of claim 13, wherein the first storage device and the second storage device are both UFS (Universal Flash Storage) devices.

17. The apparatus of claim 13,
wherein the first and second PHYs are configured to operate in compliance with M-PHY (Mobile-PHYsical-Layer),
wherein the link controller and the command queue are configured to operate in compliance with Unipro (Unified Protocol), and
wherein the transport controller is configured to operate in compliance with UTP (UFS Transport Protocol).

18. The apparatus of claim 17, wherein the transport controller is configured to generate UPIUs (UFS Protocol Information Units) as the command packets.

19. The apparatus of claim 17,
wherein the first storage device comprises a first device PHY interface, a first device link interface, and a first device transport interface,
wherein the second storage device comprises a second device PHY interface, a second device link interface, and a second device transport interface,
wherein the first and second device PHY interfaces are configured to operate in compliance with the M-PHY,
wherein the first and second device link interfaces are configured to operate in compliance with the Unipro, and
wherein the first and second device transport interfaces are configured to operate in compliance with the UTP.

20. The apparatus of claim 13, wherein the command queue is configured to provide each queued command packet to the second link one at a time in a FIFO (first-in-first-out) manner.

21. The apparatus of claim 13, wherein the link controller does not queue the command packets received from the transport controller.

22. The apparatus of claim 13, wherein the host is configured to put one or more of the link controller, the first PHY, and the first storage device in a deep-sleep mode if the transport controller does not receive any request message targeting the first storage device for a first threshold duration.

23. The apparatus of claim 13, wherein the host is configured to put one or more of the command queue, the second PHY, and the second storage device in a deep-sleep mode if the command queue is empty for a second threshold duration.

24. The apparatus of claim 13, wherein the apparatus is incorporated into a device selected from a group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

25. A method of an apparatus comprising a host configured to access first and second storage devices, the method comprising:
receiving, by a transport controller, one or more request messages from an HCI (host controller interface);
generating, by the transport controller, a command packet corresponding to each request message;
determining, by the transport controller, a target of each request message;
sending, by the transport controller to a link controller, each command packet whose corresponding request message targets the first storage device;
sending, by the transport controller to a command queue, each command packet whose corresponding request message targets the second storage device;
sending, by the link controller, each command packet received from the transport controller to a first PHY for transmission to the first storage device over a first connection;
queueing, by the command queue, the command packets received from the transport controller; and
sending, by the command queue, each queued command packet to a second PHY one at a time for transmission to the second storage device over a second connection.

26. The method of claim 25, wherein link controller providing the received command packets to the first PHY concurrently occurs with the command queue providing the queued command packets to the second PHY.

27. The method of claim 25,
wherein the first storage device is an embedded storage device integrated with the host, and
wherein the second storage device is an external storage card removable from the host.

28. The method of claim 25, wherein the first storage device and the second storage device are both UFS (Universal Flash Storage) devices.

29. The method of claim 25, wherein the transport controller generates UPIUs (UFS Protocol Information Units) as the command packets.

30. The method of claim 25, wherein the link controller does not queue the command packets received from the transport controller.

31. The method of claim 25, further comprising putting one or both of the link controller and the first PHY in a deep-sleep mode if the transport controller does not receive any request message targeting the first storage device for a first threshold duration.

32. The method of claim 25, further comprising putting one or both of the command queue and the second PHY in a deep-sleep mode if the command queue is empty for a second threshold duration.

33. An apparatus, comprising:
a host configured to access first and second storage devices, the host comprising:
a first PHY configured to communicate with the first storage device over a first connection, and a second PHY configured to communicate with the second storage device over a second connection;
a link controller configured to interface with the first PHY over a first link;
command queue configured to interface with the second PHY over a second link; and
a transport controller configured to interface with the link controller and with the command queue,
wherein the transport controller comprises:
means for receiving one or more request messages from an HCI (host controller interface);
means for generating a command packet corresponding to each request message;
means for determining a target of each request message;
means for sending each command packet whose corresponding request message targets the first storage device to the link controller; and
means for sending each command packet whose corresponding request message targets the second storage device to the command queue,
wherein the link controller is configured to provide each command packet received from the transport controller to the first link for transmission to the first storage device over the first connection by the first PHY, and
wherein the command queue comprises:
means for queuing command packets received from the transport controller, and
means for providing each queued command packet to the second link one at a time for transmission to the second storage device over the second connection by the second PHY.
